(19) United States
(12) Patent Application Publication
(10) Pub. No.: US 2017/0120940 A1
(43) Pub. Date: May 4, 2017

(54) DUAL ORIENTATION ROLLING CONTAINER

(71) Applicant: GM Global Technology Operations LLC, Detroit, MI (US)

(72) Inventors: WADE W. BRYANT, GROSSE POINTE FARMS, MI (US); RICHARD J. LANNEN, ROYAL OAK, MI (US); THOMAS J. SUSTARICH, MACOMB, MI (US)

(21) Appl. No.: 14/929,557

(22) Filed: Nov. 2, 2015

(51) Int. Cl. B62B 3/02

(52) U.S. Cl. CPC B62B 3/02

(57) ABSTRACT

A container may include six sides that may define eight corners. Six wheels may be included with one disposed at each of six of the eight corners.

### TECHNICAL FIELD

The field to which the disclosure generally relates includes containers, and more particularly, includes containers for storing or moving goods.

### BACKGROUND

Containers have been in use as long as the needs have existed to contain, store and move articles. For manufactured goods, a number of factors enter into the design of a container, including the type of good that will be deposited into the container. As manufacturing and transportation methods evolve, needs continually arise for new and useful containers.

### SUMMARY OF ILLUSTRATIVE VARIATIONS

A number of illustrative variations may involve a container that may include six sides that may define eight corners. Six wheels may be included with one disposed at each of six of the eight corners.

A number of additional illustrative variations may involve a container that may include a number of sides that may define a contained area. A door may extend across a part of at least two of the number of sides. The container may be positioned in an upright orientation with one of the sides forming a top on an uppermost of the number of sides. The container may be positioned in a horizontal orientation with another one of the sides forming the top. The door may be openable to expose the contained area through a portion of the top in each of the upright and the horizontal orientations.

A number of other illustrative variations may involve a container that may include a number of sides that may define a contained area. A handle assembly may be connected to at least one of the number of sides. A lock may hold the handle assembly in a number of positions in relation to the container. The lock may include a number of receptacles. A slide may engage in the receptacles to hold the handle in the positions.

Other illustrative variations within the scope of the invention will become apparent from the detailed description provided herein. It should be understood that the detailed description and specific examples, while disclosing variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 illustrates a container according to a number of variations.

FIG. 2 is a schematic view illustrating the container of FIG. 1 according to a number of variations.

FIG. 3 illustrates a container according to a number of variations.

FIG. 4 illustrates the use of a container according to a number of variations.

FIG. 5 illustrates the use of a container according to a number of variations.

FIG. 6 illustrates a container according to a number of variations.

FIG. 7 illustrates a container according to a number of variations.

FIG. 8 illustrates a container according to a number of variations.

FIG. 9 illustrates a container according to a number of variations.

FIG. 10 illustrates a container handle assembly according to a number of variations.

FIG. 11 illustrates a release mechanism for a container handle assembly according to a number of variations.

FIG. 12 illustrates a release mechanism for a container handle assembly according to a number of variations.

FIG. 13 is an isometric view illustrating a part of the container of FIG. 1 according to a number of variations.

FIG. 14 illustrates a part of an axle assembly of the container of FIG. 13 according to a number of variations.

FIG. 15 illustrates a part of an axle assembly of the container of FIG. 13 according to a number of variations.

### DETAILED DESCRIPTION OF ILLUSTRATIVE VARIATIONS

The following description of the variations is merely illustrative in nature and is in no way intended to limit the scope of the invention, its application, or uses.

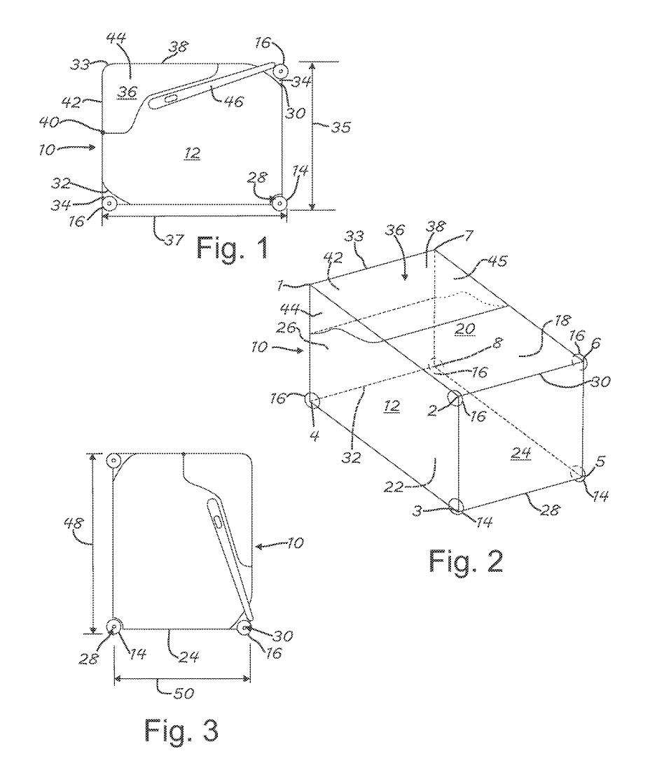

In a number of variations as illustrated in FIG. 1, a side 12 of a container 10 is shown. The container 10 may have a body with the side 12 being substantially rectangular for efficient packing of a number of like containers. The container 10 may include a number of wheels that may be of multiple types, and may include straight rolling wheels 14 and multi-directional wheels 16. The multi-directional wheels 16 may be omni-wheels that can roll straight, and may also readily slide laterally. In a number of variations, all wheels may be straight rolling wheels, or all wheels may be multi-directional wheels, or all wheels may be another suitable type of wheel, or multiple types of wheels. With additional reference to FIG. 2, which in schematic form shows that the container 10 may be box shaped, and may include six sides defining eight corners 1-8, each located where three sides meet. More particularly, the container 10 may be a three-dimensional structure with three sets of opposed sides defining or containing a closed internal space. More specifically, the side 12 (left side as viewed), may be opposed by a side 18 (right side as viewed). A side 20 (top as viewed), may be opposed by a side 22 (bottom as viewed). A side 24 (front as viewed), may be opposed by a side 26 (back as viewed). A corner 28 along the container 10 where the two sides 22 and 24 meet may extend between the corners 3 and 5 and may include a pair of the straight rolling wheels 14 at the corners 3 and 5. A corner 30 along the container 10 where the two sides 20 and 24 meet may extend between the corners 2 and 6 and may include a pair of the multi-directional wheels 16 at the corners 2 and 6. Another corner 32 along the container 10 where the two sides 22 and 26 meet may extend between the corners 4 and 8 and may include a pair of the multi-directional wheels 16 at the corners 4 and 8. A corner 33 along the container 10 where the two sides 20 and 26 meet may extend between the corners 1 and 7 and may be free of wheels. The corners 1-8 may be referred to as three-sided corners and the corners 28, 30, 32 and 33 may be referred to as two-sided corners. The sides 12, 18, 20 and 22 may be long sides that may be longer than the sides 24 and 26, which may be short sides. The FIG. 1 orientation of the container 10 may be referred to as a horizontal orientation. With the container oriented as shown in FIGS. 1 and 2, the container 10 may roll on the wheels at the corners 28 and 32 and may have a vertical height 35 and a horizontal length 37. As shown in FIG. 1, the corners 30 and 32 may be cut or chamfered and the multi-directional wheels 16 may be mounted on plates 34 that may project from the container 10. Two of the multi-directional wheels 16 may be used to turn or steer the container 10, which along with the two wheels 14 support the container 10 for rolling movement in the horizontal orientation.

In a number of variations the container 10 may include a door 36 that may extend around one of the corners such as the corner 33, and may be referred to as an “over the corner” door. The door 36 may have a panel 38, which may define a part of the side 20. Another panel 42 of the door 36 may define a part of the side 26 and may be connected thereto by a hinge 40. In a number of variations the panel 38 may be hinged to the container 10 instead of, or in addition to, the hinge 40. The door 36 may include a side panel 44 that may define an area of a part of the side 12 adjacent the corner 33. An opposite side panel 45 of the door 36 may define a part of the side 18 adjacent the corner 33. The shape of the side panels may vary, including to provide a desired amount of access to the container 10 when the door 36 is opened. In a number of variations the container may include a handle assembly 46 that is described in more detail below.

Referring to FIG. 3, in a number of variations the container 10 may be oriented with the side 24 on the bottom. This orientation of the container 10 may be referred to as an upright orientation. With the container oriented as shown in FIG. 3, the container 10 may roll on the wheels at the corners 28 and 30 and may have a vertical height 48 and a horizontal length 50. The vertical height 48 may be greater than the vertical height 35 and the horizontal length 50 may be less than the horizontal length 37. The two multi-directional wheels 16 on the corner 30 may be used to turn or steer the container 10, which along with the two wheels 14 may support the container 10 for rolling movement. In a number of variations the container 10 may be oriented as shown in FIG. 3 for movement through tight passageways or spaces such as within vehicles for transport or for movement through hallways and elevators.

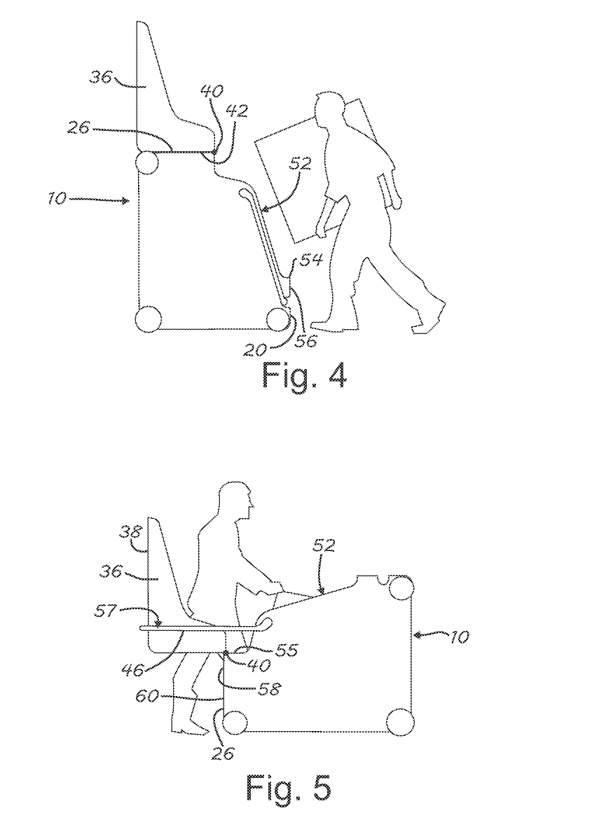

With reference to FIG. 4, in a number of variations, the container 10 may be positioned in the upright orientation of FIG. 3. The door 36 may be opened by rotation on the hinge 40 to provide an access opening 52 into the container 10. The access opening 52 may have a relatively low threshold 54, which may be defined by a remaining portion 56 of the side 20. The door 36 may be located above the remainder of the container 10 with the panel 42 resting against the remainder of the side 26 so that the door 36 may be stably stored in an open position. The access opening 52 may present a convenient passage for loading articles into the container 10 and for removing articles therefrom.

In a number of variations as illustrated in FIG. 5, the container 10 may be positioned in the horizontal orientation of FIG. 1. The door 36 may be opened by rotation on the hinge 40 to provide the access opening 52 into the container 10. The handle assembly 46 may be positioned in a support position 57, where it may be locked. The support position 57 may be horizontal, or substantially horizontal, with the panel 38 resting against the handle assembly 46. The handle assembly 46 may stably support the door 36 in a second open position that preserves floor space around the container 36. The access opening 52 may have a relatively high threshold 55 as compared to the threshold 54, which may be defined by a remaining portion 60 of the side 26. The access opening 52 may present a convenient passage for loading articles into the container 10 and for removing articles therefrom with a substantial portion of the side 26 positioned vertically to contain articles.

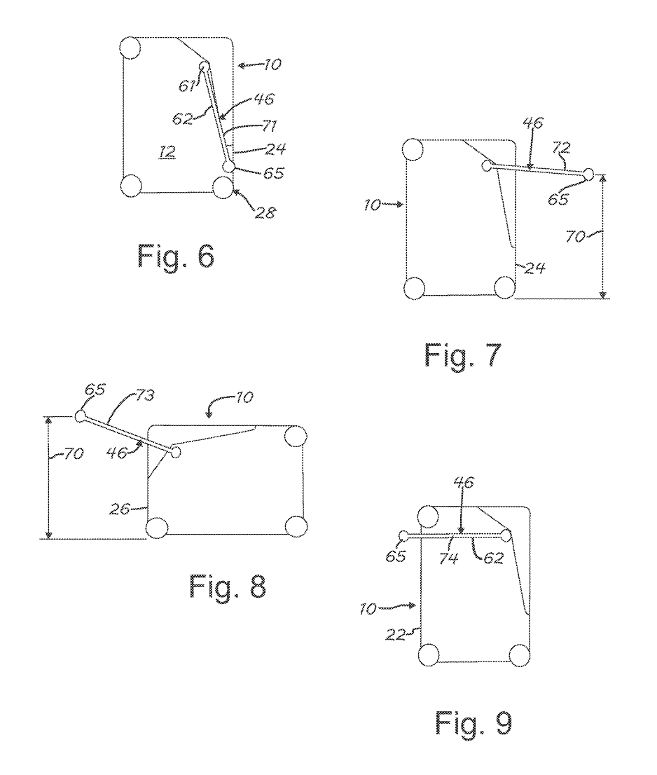

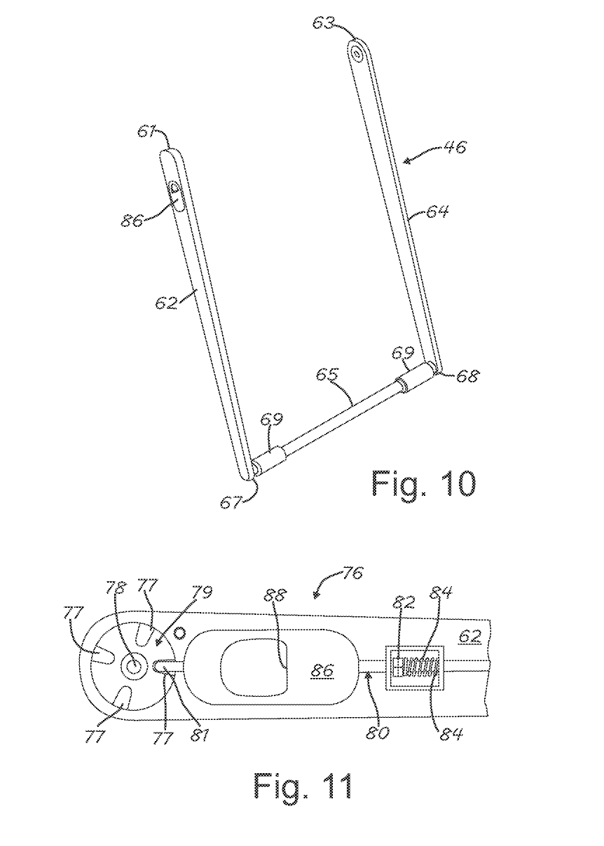

In a number of variations the container 10 may include multiple positions of the handle assembly 46, as illustrated in FIGS. 6 through 9. The handle assembly 46 may include a side arm 62 that may have a proximal end 61 that may be connected to the container 10 on the side 12. As shown in FIG. 10, in a number of variations the handle assembly 46 may have a second side arm 64 that may be similar to the side arm 62 and may have a proximal end 63 that may be connected to the container 10 on the side 18 opposite the side 12. A handle 65 may extend between a distal end 67 of the side arm 62 and a distal end 68 of the side arm 64. A pair of release handles 69 may be positioned on the handle 65 and are described in more detail below.

As shown in FIG. 6, the handle assembly 46 may be secured in a first position 71 where the handle 65 may be positioned adjacent or, as shown, against the side 24 near the corner 28. This first position 71 may be referred to as a stored position where the handle 65 is stored with its length against or near the container 10 to facilitate stacking containers closely together such as for shipping. As shown in FIG. 7, the handle assembly 46 may be secured in a second position 72 where the handle 65 may be positioned away from the side 24 at an ergonomically apt hand height 70 for using the handle 65 to manually move the container 10 when it is in the upright orientation of FIG. 3. This second position 72 may be referred to as an upright trailing position where the handle 65 is located conveniently for pulling the container 10, although other modes of movement, such as pushing, may be employed in this position. The second position 72 may coincide with the support position 57 of FIG. 5, or may be separate therefrom, depending on the height of the container 10 and other factors. As shown in FIG. 8, the handle assembly 46 may be secured in a third position 73 where the handle 65 may be positioned away from the side 26 at an ergonomically apt hand height 70 for using the handle 65 to manually move the container 10 when it is in the horizontal orientation of FIG. 1. This third position 72 may be referred to as a horizontal trailing position where the handle 65 is located conveniently for pulling the container 10, although other modes of movement, such as pushing, may be employed in this third position 73. As shown in FIG. 9, the handle assembly 46 may be secured in a fourth position 74 where the handle 65 may be positioned a relatively short distance away from the side 22 at an ergonomically apt height for using the handle 65 to manually move the container 10 when it is in the upright orientation. In this fourth position the side arms 62 and 64 may extend across the outside of the container 10. This fourth position 74 may be referred to as a guiding position where the handle 65 is located conveniently for pushing or guiding the container 10, although other modes of movement may be employed in this position. Any number of positions may be provided for the handle assembly 46 relative to the container 10. In a number of variations the handle 65 may be disposed at hand height 70 in each of the upright and horizontal orientations. Hand height 70 may be a height that is conveniently grasped and manipulated by a person of average height in an ergonomic manner without stooping or stretching upward.

In a number of variations the handle assembly 65 may be lockable in the first through fourth positions 71-74, and may be lockable in the support position 57. With reference to FIG. 11 the handle assembly 46 may include a lock assembly 76, which may be provided at or near the proximal end 61, 63 of one or both of the side arms 62, 64. The lock assembly 76 may include a lock 79 that may be secured to the container 10 so that it does not rotate relative thereto. The lock 79 may be disk shaped and may be secured to the container 10 such as through a fastener 78. The lock 79 may include a number of receptacles 77. In a number of variations the lock 79 may include four receptacles, one corresponding to each of the positions 71-74 of the handle assembly 46. A slide 80 may extend through the side arm 62. The slide 80 may include a tip 81 that may be received within each of the receptacles 77 and may be selectively withdrawn therefrom. The slide 80 may be a rod, cable, pin, wire, link, a combination thereof, or another structure that may transmit movement through the side arm 62 and that may engage within the receptacles 77 of the lock 79. A stop 82 may be secured on the slide 80 or may be formed as part thereof. A spring 84 may extend between the stop 82 and a shoulder 84 on the side arm 62 and may apply a force to bias the slide 80 toward the lock 79 to act to move the tip 81 into a receptacle 77 when aligned therewith, and to hold the tip 81 in a receptacle 77. A slide release 86 may be engaged with the slide 80 and may include a finger grip 88 for manually moving the tip 81 out of a receptacle for repositioning the handle assembly 46.

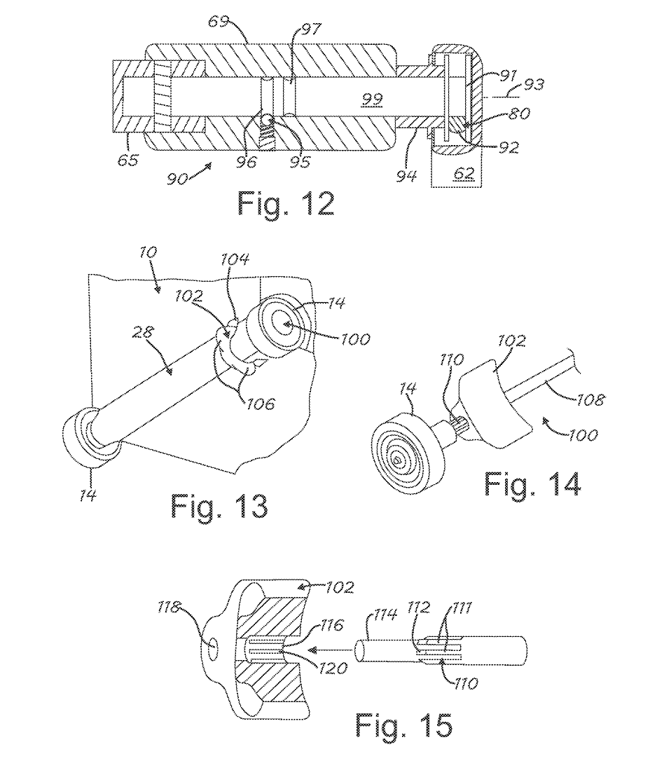

In a number of variations the handle assembly 46 may include a twist release mechanism 90 as shown in FIG. 12. The twist release mechanism may be provided on one or both of the side arms 62, 64. The twist release mechanism 90 may include a cam 91 that may be engaged with an end 92 of the guide 80. The connection between the end 92 and the cam 91 may be offset from the centerline 93 of the twist release mechanism 90 to increase the amount the slide 80 moves when the cam 91 is rotated. The cam 91 may be engaged with the release handle 69 through a rod 99 and a connector 94 so that the cam 91 may be rotated by the release handle 69. A detent 95 may provide a stop for alternate positions of the release handle 69. A first detent position 96 may be obtained by forcing the release handle 69 toward its respective side arm, in this case side arm 62. In the first detent position 96, the connector 94 may engage with the cam 91 to transmit rotation thereto from the release handle 69. A second detent position 97, may be obtained by forcing the release handle 69 away from the side arm 62. In the second detent position 97, the connector 94 may be disengaged from the cam 91 so that rotation of the release handle 69 does not inadvertently release the handle assembly 46.

In a number of variations as illustrated in FIG. 13 the wheels 14 may be connected to the corner 28 through an axle assembly 100. The axle assembly 100 may include a lock slide 102 that may extend out from an opening 104 in the container 10. The lock slide 102 may include a pair of tabs 106 projecting outward to facilitate manipulation of the lock slide 102. As shown in FIGS. 14 and 15 the axle assembly 100 may include an axle 108 that may extend between the two wheels 14. The axle 108 may include a splined section 110 that extends over only a portion of the axle 108. The splines 111 may each include a lead-in ramp 112 at a juncture between the splined section 110 and a non-splined section 114. The lock slide 102 may have an opening 116 that may include a first section 118 that matches the non-splined section 114 and a second section 120 that matches the splined section 110. When the second section is slid onto the splined section 111 the axle assembly 100 may be locked to lock the wheels 14 from rotating and to secure the container 10 in position. When the second section 120 is slid over the non-splined section 114, the axle assembly 100 may be unlocked and the wheels 14 may turn. The lock slide 102 may be engaged with the splined section 110, and disengaged therefrom, by pushing on the tabs 106.

Through the forgoing variations a dual orientation rolling container may be provided for containing, moving and storing articles, and which may be efficiently stacked for storage or transportation. The following description of variants is only illustrative of components, elements, acts, products and methods considered to be within the scope of the invention and are not in any way intended to limit such scope by what is specifically disclosed or not expressly set forth. The components, elements, acts, products and methods as described herein may be combined and rearranged other than as expressly described herein and still are considered to be within the scope of the invention.

Variation 1 may involve a container that may include six sides that may define eight corners. Six wheels may be included with one disposed at each of six of the eight corners.

Variation 2 may include the container of variation 1 and may include a door that may cover a part of two of the six sides.

Variation 3 may include the container of variation 2 wherein a top of the container may be defined by one of the two sides.

Variation 4 may include the container of variation 1 and may include a handle assembly that may be connected to the container. A lock may hold the handle assembly in a number of positions.

Variation 5 may include the container of variation 4 wherein in one of the positions, the handle assembly may support the door when the door is open.

Variation 6 may include the container of variation 4 wherein the handle assembly may include a slide release that may slide to release the lock.

Variation 7 may include the container of variation 4 wherein the handle assembly may include a twist release that may twist to release the lock.

Variation 8 may include the container of variation 4 wherein the handle assembly may include a handle. In one of the positions the handle may be positioned against the container.

Variation 9 may include the container of variation 1 wherein four of the sides may be longer than the remaining two sides.

Variation 10 may include the container of variation 9 wherein the container may be supported on four of the six wheels when one of the four sides is at a bottom of the container.

Variation 11 may include the container of variation 10 wherein the container may be supported on four of the six wheels when one of the remaining two sides is at a bottom of the container.

Variation 12 may include the container of variation 1 and may include an axle assembly that may be connected to two of the six wheels. An axle may include a splined section and a lock slide that may be selectively engaged with the splined section to lock the axle assembly.

Variation 13 may involve a container that may include a number of sides that may define a contained area. A door may extend across a part of at least two of the number of sides. The container may be positioned in an upright orientation with one of the sides forming a top on an uppermost of the number of sides. The container may be positioned in a horizontal orientation with another one of the sides forming the top. The door may be openable to expose the contained area through a portion of the top in each of the upright and the horizontal orientations.

Variation 14 may include the container of variation 13 and may include a bottom opposite the top wherein four wheels may be disposed on the bottom in each of the upright and horizontal orientations.

Variation 15 may include the container of variation 14 and may include a lock on two of the four wheels in each of the upright and horizontal orientations.

Variation 16 may include the container of variation 13 and may include a handle that may extend from the container and may be positionable to hand height in each of upright and horizontal orientations.

Variation 17 may include the container of variation 13 and may include a handle assembly that may have a pair of side arms one of which may be connected to a first of the number of sides and the other of which may be connected to a second of the number of sides that is opposite the first of the number of sides. A handle may extend between the side arms. The handle may be positionable to a stored position that may be substantially against the container.

Variation 18 may involve a container that may include a number of sides that may define a contained area. A handle assembly may be connected to at least one of the number of sides. A lock may hold the handle assembly in a number of positions in relation to the container. The lock may include a number of receptacles. A slide may engage in the receptacles to hold the handle in the positions.

Variation 19 may include the container of variation 18 wherein the handle assembly may include a slide release that may be connected to the slide. The slide release may be moveable to disengage the slide from the receptacles.

Variation 20 may include the container of variation 19 wherein the handle assembly may include a twist release that may be connected to the slide and that may twist to disengage the slide from the receptacles.

The above description of select variations within the scope of the invention is merely illustrative in nature and, thus, variations or variants thereof are not to be regarded as a departure from the spirit and scope of the invention.

What is claimed is:

1. A container comprising six sides defining eight corners, and six wheels, one disposed at each of six of the eight corners.

2. The container according to claim 1 further comprising a door covering a part of two of the six sides.

3. A container according to claim 2 wherein a top of the container is defined by one of the two sides.

4. The container according to claim 1 further comprising a handle assembly connected to the container and a lock holding the handle assembly in a number of positions.

5. The container according to claim 4 wherein in one of the positions, the handle assembly supports the door when the door is open.

6. The container according to claim 4 wherein the handle assembly includes a slide release that slides to release the lock.

7. The container according to claim 4 wherein the handle assembly includes a twist release that twists to release the lock.

8. The container according to claim 4 wherein the handle assembly includes a handle and wherein in one of the positions the handle is positioned against the container.

9. The container according to claim 1 wherein four of the sides are longer than the remaining two sides.

10. The container according to claim 9 wherein the container is supported on four of the six wheels when one of the four sides is at a bottom of the container.

11. The container according to claim 10 wherein the container is supported on four of the six wheels when one of the remaining two sides is at a bottom of the container.

12. A container according to claim 1 further comprising an axle assembly connected to two of the six wheels, and including an axle with a splined section and a lock slide that is selectively engaged with the splined section to lock the axle assembly.

13. A container comprising a number of sides defining a contained area, a door extending across a part of at least two of the number of sides, the container positionable in an upright orientation with one of the sides forming a top on an uppermost of the number of sides, and positionable in a horizontal orientation with another one of the sides forming the top, and the door openable to expose the contained area through a portion of the top in each of the upright and the horizontal orientations.

14. The container according to claim 13 further comprising a bottom opposite the top wherein four wheels are disposed on the bottom in each of the upright and horizontal orientations.

15. The container according to claim 14 further comprising a lock on two of the four wheels in each of the upright and horizontal orientations.

16. The container according to claim 13 further comprising a handle connected to the container and extending from the container so that the handle is positionable to a hand height in each of upright and horizontal orientations.

17. The container according to claim 13 further comprising a handle assembly that has a pair of side arms one of which is connected to a first of the number of sides and the other of which is connected to a second of the number of sides that is opposite the first of the number of sides, a handle extending between the side arms, the handle positionable to a stored position that is substantially against the container.

18. A container comprising a number of sides defining a contained area, a handle assembly connected to at least one of the number of sides and including a lock holding the handle in a number of positions in relation to the container, the lock including a number of receptacles, and a slide that engages in the receptacles to lock the handle assembly.

19. The container according to claim 18 wherein the handle assembly includes a slide release connected to the slide that is moveable to disengage the slide from the receptacles.

20. The container according to claim 19 wherein the handle assembly includes a twist release connected to the slide that twists to disengage the slide from the receptacles.
